(19) United States
(12) Patent Application Publication
(10) Pub. No.: US 2005/0157205 A1
(43) Pub. Date: Jul. 21, 2005

(54) Combination LED and strobe lighting device

(76) Inventors: James S. Voss, Fort Collins, CO (US); William Robert Haas, Fort Collins, CO (US); Kirk Steven Tecu, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/762,871

(22) Filed: Jan. 21, 2004

(51) Int. Cl. H04N 5/222

(52) U.S. Cl. 348/370

(57) ABSTRACT

A lighting device for a digital camera is built including one or more light emitting diodes (LEDs) along with a strobe. The LEDs are configured to provide lighting of the subject during a video mode of the camera and the strobe is configured to provide lighting of the subject during a still mode of the camera. These independent light sources may share a common reflector in some embodiments, while in other embodiments they may use separate reflectors. This lighting device may be built in to a digital camera or in some embodiments may be configured as a separate device controlled by the digital camera.

### CROSS-REFERENCE TO RELATED APPLICATION

This application is related to application Ser. No. xx/xxx,xxx entitled, “Automatic Selection of Illumination Source for Hybrid Digital Cameras,” filed on or about the same date as the present application, and hereby incorporated herein by reference. application Ser. No. xx/xxx,xxx discloses and claims a method for the automatic selection of illumination sources by digital cameras.

### FIELD OF THE INVENTION

The present invention relates generally to the field of photography and more specifically to the field of lighting of photographic subjects for still and video imaging.

### BACKGROUND OF THE INVENTION

Many modem digital cameras include both a still photography mode and a video mode. In the video mode, short moving video clips are captured by the digital camera. These video clips may range in length from a few seconds to several minutes. The lighting requirements for these two modes of operation are significantly different. In digital still cameras a very bright flash for scene illumination is often desired so that high shutter speeds can be used to stop and freeze any motion in the scene being captured. In video mode, a more uniform constant light source is desired.

### SUMMARY OF THE INVENTION

A lighting device for a digital camera is built including one or more light emitting diodes (LEDs) along with a strobe. The LEDs are configured to provide lighting of the subject during a video mode of the camera and the strobe is configured to provide lighting of the subject during a still mode of the camera. These independent light sources may share a common reflector in some embodiments, while in other embodiments they may use separate reflectors. This lighting device may be built-in to a digital camera or in some embodiments may be configured as a separate device controlled by the digital camera.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is front view of an example embodiment of a digital camera including a LED and strobe lighting device according to the present invention.

FIG. 2 is front view of an example embodiment of a digital camera attached to a lighting device including a LED and a strobe according to the present invention.

FIG. 3 is a cross-sectional view of a lighting device including two LEDs, a strobe, and a single reflector according to the present invention.

FIG. 4 is a cross-sectional view of a lighting device including one LED, a strobe, and two reflectors according to the present invention.

### DETAILED DESCRIPTION

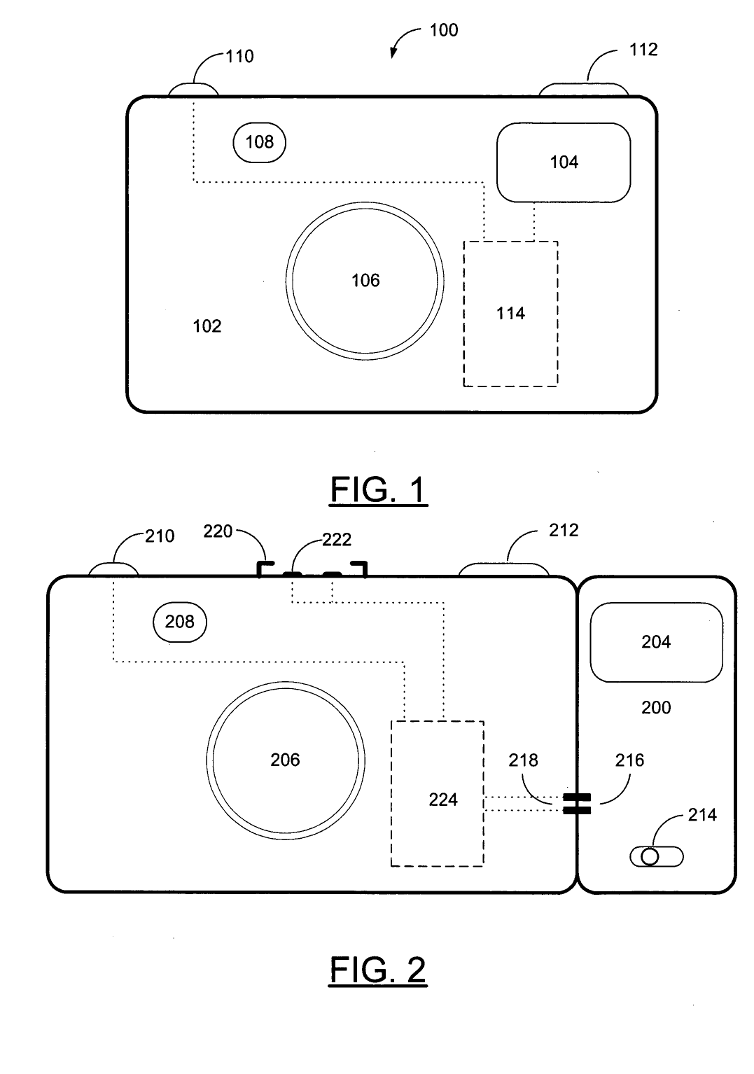

FIG. 1 is front view of an example embodiment of a digital camera including a LED and strobe lighting device according to the present invention. An example embodiment of a camera 100 constructed according to the present invention may include a camera body 102, a lens 106, a LED and strobe lighting device 104, an external viewfinder window 108, a shutter release 110, and a control 112. As with all digital cameras, this example embodiment of the present invention includes a circuit 114 electrically connected to the shutter release 110, electrically connected to the LED and strobe lighting device 104, and configured to control the lighting device 104 by activating either the LED or the strobe within the lighting device. This circuit 114 includes a means for detecting when the shutter release 110 is depressed. In some example embodiments of the present invention, the circuit 114 may also be configured to detect when the shutter release 110 is partially depressed. In an example embodiment of the present invention, the control 112 may be used to select a mode of the digital camera. These modes may include a still photo mode and a video mode.

FIG. 2 is front view of an example embodiment of a digital camera attached to a lighting device including a LED and a strobe according to the present invention. In this embodiment of the present invention the lighting device including a LED and a strobe is configured as a separate device from the digital camera. Similar to the digital camera of FIG. 1, this example embodiment of a camera includes a camera body 202, a lens 206, an external viewfinder window 208, a shutter release 210, a control 212, a hot shoe 220 including hot shoe electrical contacts 222. As with all digital cameras, this example embodiment of the present invention includes a circuit 224 electrically connected to the shutter release 210, electrically connected to the hot shoe electrical contacts 222 and the flash control outputs 218. The circuit 224 is configured to control one or more external lighting devices through the hot shoe electrical contacts 222 or the flash control outputs 218. This circuit 224 includes a means for detecting when the shutter release 210 is depressed. In some example embodiments of the present invention, the circuit 224 may also be configured to detect when the shutter release 210 is partially depressed. In an example embodiment of the present invention, the control 212 may be used to select a mode of the digital camera. These modes may include a still photo mode and a video mode. This example embodiment also includes dedicated flash control outputs 218 separate from the hot shoe electrical contacts 222. Both the flash control outputs 218 and the hot shoe electrical contacts 222 may be used to control a mode of the lighting device 200. This example embodiment of a lighting device 200 includes a combined LED and strobe 204, flash control inputs 216, and a switch 214. The flash control inputs 216 and the switch 214 may be used to select a mode of the flash. In a still mode, the strobe of the flash is activated when triggered by the camera. In a video mode, the LED is activated when triggered by the camera. In an example embodiment of the present invention, the switch 214 may allow a user to override the mode signal communicated from the camera through the flash control outputs 218 into the flash control inputs 216 of the lighting device 200.

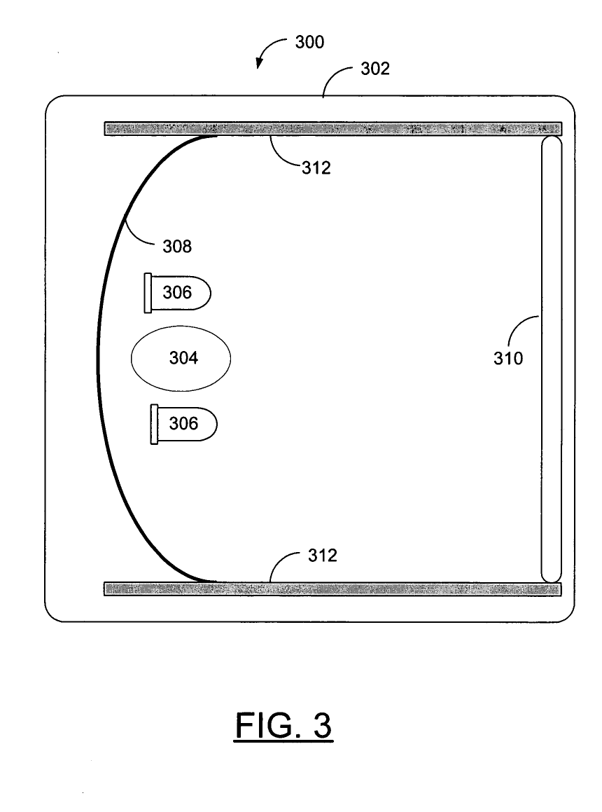

FIG. 3 is a cross-sectional view of a lighting device including two LEDs, a strobe, and a single reflector according to the present invention. In this example embodiment of the present invention a lighting device 300 is built including a body 302 with supports 312 for a reflector 308 and a lens 310. In this example embodiment two LEDs 306 share the common reflector 308 with a strobe tube 304. Those of skill in the art will recognize that many different configurations of LEDs and strobe tubes may be used within the scope of the present invention. While this example embodiment includes two LEDs 306 positioned on either side of a strobe tube 304 other embodiments may use any number of LEDs 306 positioned in widely varying locations with respect to the strobe tube 304. Also, other embodiments of the present invention may use more than one strobe tube 304.

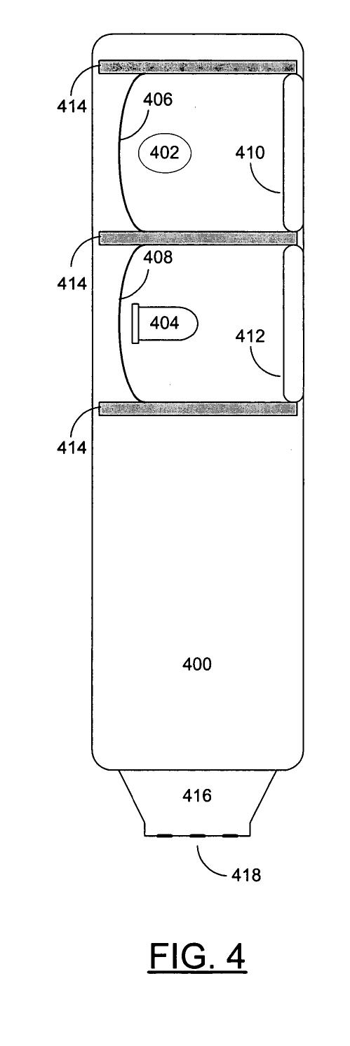

FIG. 4 is a cross-sectional view of a lighting device including one LED, a strobe, and two reflectors according to the present invention. In this example embodiment of the present invention a lighting device 400 is built including a body with supports 414 configured to mechanically affix a first reflector 406, a first lens 410, a second reflector 408, and a second lens 412. A strobe tube 402 is configured to use the first reflector 406 and the first lens 410, while a LED 404 is configured to use the second reflector 408 and the second lens 412. This embodiment of the present invention includes a hot shoe foot 416 including flash input connections 418 configured to electrically couple to the hot shoe of the camera shown in FIG. 2. Those of skill in the art will recognize that many different quantities and configurations of strobe tubes and LEDs may be used within the scope of the present invention. While many implementations of the present invention will use white LEDs for video illumination, other colors of LEDs may be used either in place of, or in addition to white LEDs to change the color of the light generated by the lighting device.

In other embodiments of the present invention, the LED and strobe illumination device may be configured as a device separate from the camera. It may attach to the camera via a hot shoe, and additional signals within the hot shoe may control the mode of the illumination device. In some simple embodiments of the present invention the mode of the illumination device may be controlled by the user of the camera with a switch.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A device having a still mode and a video mode, comprising:
a body;
a strobe tube mechanically coupled to said body, configured to operate during said still mode; and
at least one LED mechanically coupled to said body, configured to operate during said video mode.

2. The device recited in claim 1, further comprising:
a switch configured to switch said device between said still mode and said video mode.

3. The device recited in claim 1, further comprising:
a control configured to switch said device between said still mode and said video mode.

4. The device recited in claim 1, further comprising:
at least one flash control input configured to receive a mode signal from a digital camera and switch said device between said still mode and said video mode.

5. The device recited in claim 4, wherein:
said flash control input is configured to electrically couple to a hot shoe.

6. The device recited in claim 1, further comprising:
a reflector mechanically coupled to said body, configured to reflect light from said strobe tube and said at least one LED onto a photographic subject.

7. The device recited in claim 1, further comprising:
a first reflector mechanically coupled to said body, configured to reflect light from said strobe tube onto a photographic subject; and
a second reflector mechanically coupled to said body, configured to reflect light from said at least one LED onto a photographic subject.

8. The device recited in claim 1, wherein:
said strobe tube is a xenon strobe tube.

9. The device recited in claim 1, wherein:
said at least one LED is a white LED.
